(19) United States
(12) Patent Application Publication
(10) Pub. No.: US 2008/0057938 A1
(43) Pub. Date: Mar. 6, 2008

(54) Method and Apparatus of Presenting Content Received at a Wireless Communication Device

(75) Inventor: Gregory A. Dunko, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/468,428

(22) Filed: Aug. 30, 2006

(51) Int. Cl. H04Q 7/20

(52) U.S. Cl. 455/425

(57) ABSTRACT

A wireless communication device includes an optical sensor, a controller, and a display. The optical sensor receives data transmitted by one or more optical transmitters that are associated with one or more businesses or buildings. The controller filters the received data based on selected user preference information stored in memory or provided by the user to produce a selected content. The controller displays the selected content to the user on the display.

### BACKGROUND

The present invention relates generally to wireless communication devices, and particularly to wireless communication devices configured to receive optically transmitted information.

The increasing popularity of wireless communication devices such as cell phones, for example, has driven the development of applications that use various technologies. One application in particular utilizes optical transmitters to carry information and data to suitably equipped cell phones.

The optical transmitters may be associated, for example, with businesses such as restaurants or shops and emit an optical beacon that carries information about the businesses. The information may include, inter alia, the name of the business and data representative of the business' graphical icon or mark. A cell phone equipped with an optical sensor can receive and display the information for the user on the cell phone's display.

The ability to view a variety of information about businesses on a cell phone is useful. However, a user walking through a mall or near a collection of closely-located businesses that employ this technology might only be interested in specific types of businesses. If many businesses utilized this technology, the amount of received information could be overwhelming making it difficult for a user to find information regarding a specific business or type of business.

### SUMMARY

In one embodiment of the present invention, a wireless communication device comprises an optical sensor that detects and receives data transmitted by an optical transmitter. The data may comprise one or more predetermined codes that identify different information within the data. The wireless communication device filters the received data based on user preference information to select content the user is interested in viewing, and sends that content to a display.

The user preferences may be stored, for example, in one or more user profiles. Each user profile includes different user preference information that specifies a different subset of the received data that is to be displayed to the user. The user preference information may comprise, for example, one or more codes that coincide with the codes in the received data. A controller may select a given user profile responsive to user input. Alternatively, if no user profiles exist, the controller may create a user profile based on information the user has been historically interested in viewing.

The user profiles may be stored in memory of the wireless communication device, or downloaded from a server or other entity in a wireless communication network. The user may modify the amount and/or type of content currently being displayed by switching between different user profiles, or manually actuating one or more controls on the wireless communication device to increase or decrease the amount of displayed content.

### BRIEF DESCRIPTION OF THE DRAWINGS

FIG. 1 illustrates a wireless communication device configured to receive data transmitted by optical transmitters.

FIG. 2 is a block diagram illustrating a wireless communication device configured according to one embodiment of the present invention.

FIG. 3 is a flow diagram that illustrates a method by which a wireless communication device configured according to one embodiment of the present invention filters information received from an optical transmitter.

FIG. 4 illustrates a block diagram of a communication network suitable for use in one embodiment of the present invention.

### DETAILED DESCRIPTION

The present invention allows a user of a wireless communication device to view selected information received from one or more optical transmitters based on the user's preferences. The user's preferences specify which portion or portions of received data that the user is interested in viewing. In one embodiment, the wireless communication device comprises an optical sensor that receives information from one or more optical transmitters. Each optical transmitter may be associated with a different business or building that houses a business, and emits a beacon that carries data associated with that business. The data includes one or more indicators that identify different parts of the data being transmitted. Upon receipt, the wireless communication device filters the received data by comparing the received indicators to the indicators in the user's preferences. The wireless communication device may then display the content for matching indicators to the user.

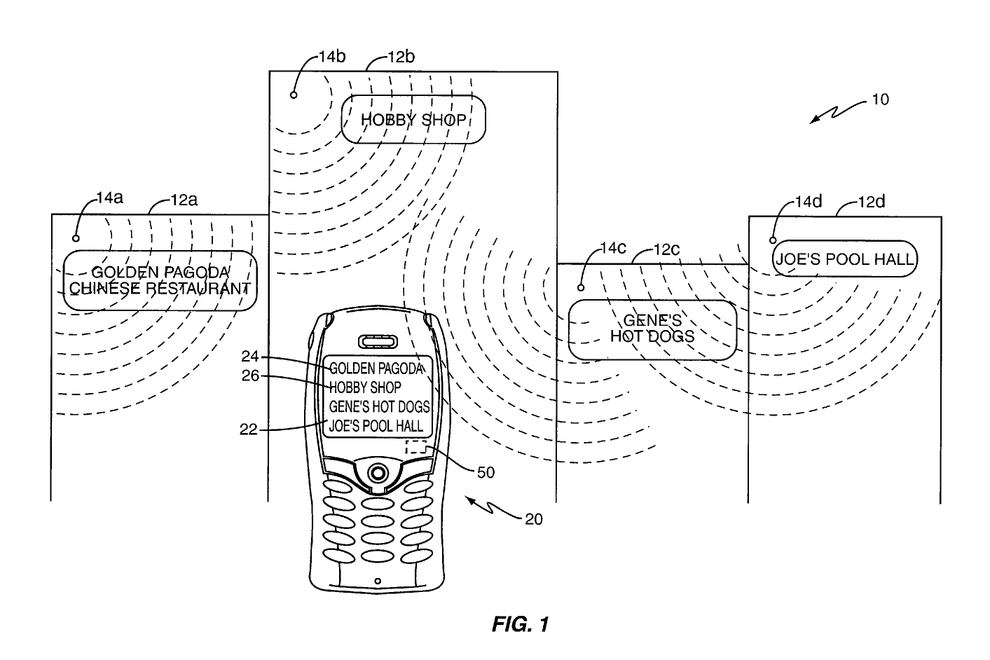

FIG. 1 is a perspective view of a geographical area 10 in which a wireless communication device 20 configured according to one embodiment of the present invention might operate. The geographical area 10 may be, for example, a large city shopping area such as Times Square in New York, Ginza in Tokyo, or the inside of a mall or other geographical location having one or more businesses or buildings 12. Each business 12 has an optical transmitter 14 that that transmits data relating to their particular business to wireless communication device 20. The data may include, but is not limited to, the name of the business, the type of food or wares it sells, pricing information, contact information, whether reservations are required, and information on sales. In one embodiment, one or more of the businesses 12 may transmit its Uniform Resource Locator (URL).

In FIG. 1, each business 12 has it own associated optical transmitter 14. However, those skilled in the art will appreciate that this is for illustrative purposes only. Any of the businesses 12a-12d may use more than one optical transmitter 14 to transmit their data, or a plurality of the businesses 12 may share a single optical transmitter 14 to transmit information relating to each of their businesses 12a-12d.

As described in more detail later, wireless communication device 12 is equipped with an optical sensor 50 that receives the data transmitted by each of the optical transmitters 14 when the wireless communication device 20 is in the line of sight of the optical transmitters 14. Upon receipt, wireless communication device 20 may display the information on a display 22 for the user. The information displayed in FIG. 1 comprises a list of text labels 24, 26 showing the user of the names of different businesses 12 in area 10 that were detected. The list might also comprise icons or other graphical indicia in addition to, or in lieu of, text. The user may select a desired business 12 from the list to view additional data about the selected business 12.

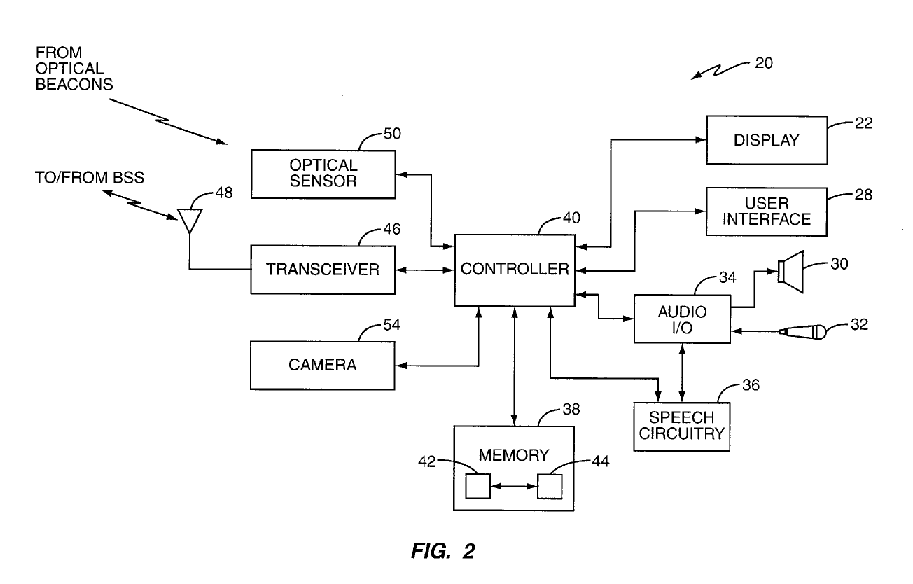

FIG. 2 illustrates some of the component parts of the wireless communication device 20 in more detail. Wireless communication device 20 includes a display 22 and a user input interface (UI) 28. The display 22 may be, for example, a touchscreen display that permits a user to employ a stylus or finger to select one of the displayed list items. “Tapping” or touching the selected list item may cause an application executing on the wireless communication device to display additional information about the business 12 associated with the selected label.

In one embodiment, selecting a particular business 12 from the list causes the wireless communication device 20 to initiate a call to that business 12. If the transmitted data includes a URL, a suitably-enabled wireless communication device 20 could launch a browser application to allow the user to view the selected business' web site. In other embodiments, selecting a particular business 12 from the list launches a browser application and automatically provides some or all of the data associated with the selected business 12 to a publicly-available search engine, such as GOOGLE. The user may then select and navigate one or more links provided by the search engine to learn more about the selected business 12.

The UI 28 includes one or more various controls that allow the user to input commands to control the operation of wireless communication device 20. Through the UI 28, the user may enter various user commands, navigate hierarchical menus, select businesses 12 and, as described later in more detail, create, edit, and maintain user preferences to control the amount and/or type of information received from the optical transmitters 14.

Wireless communication device 20 may also comprise a speaker 30 and a microphone 32 communicatively connected to an audio processing circuit 34. Speaker 30 converts audio signals into audible sound for the user, and microphone 32 converts the user's speech into electrical audio signals. The audio processing circuit 34 provides the basic analog output signals to speaker 30 and accepts analog audio inputs from microphone 32.

In some embodiments, the audio processing circuit 34 may include, or be communicatively connected to, audio processing circuitry 36 that recognizes and interprets the user's speech. Instead of manually selecting a business 12 from the list using a stylus or UI 28, the user may select a particular business 12 by speaking the text into the microphone 32. The speech processing circuitry 36 could then provide a signal to controller 40 that causes a controller 40 to perform functionality associated with the selected business 12. To facilitate this functionality, the optical transmitters 14 may transmit information representing the linguistic content of one or more of the text labels 24, 26 in the list.

Memory 38 represents the entire hierarchy of memory in wireless communication device 20, and may include both random access memory (RAM) and read-only memory (ROM). Computer program instructions and data required for operation are stored in non-volatile memory, such as EPROM, EEPROM, and/or flash memory, and may be implemented as discrete devices, stacked devices, or integrated with controller 40.

Memory 38 may store the information and data received from optical transmitters 14 and one or more user profiles 42 that contain user preference information. The controller 40, as discussed in more detail later, may use the user preference information in the user profiles 42 to filter the received data and determine which information is important to the user. Based on this filtering, controller 40 will display selected content on display 22 that matches the user's preferences. Memory 38 may also store one or more application programs 44 that are executed by controller 40. An example of one such application program 44 is the application that controls the wireless communication device 20 to receive the data from optical transmitters 14.

Controller 40 controls the operation of wireless communications device 20, and may be implemented in a single microprocessor, or in multiple microprocessors. Suitable microprocessors may include both general purpose and special purpose microprocessors and digital signal processors. As those skilled in the art will readily appreciate, memory 38 and controller 40 may be incorporated into a specially designed application-specific integrated circuit (ASIC).

Transceiver 46 is a fully functional cellular radio transceiver coupled to an antenna 48 for receiving and transmitting signals over a wireless communications network (not shown). Transceiver 46 may operate according to any known standard, including but not limited to, Global System for Mobile Communications (GSM), Universal Mobile Telecommunication System (UMTS), TIA/EIA-136, Code Division Multiple Access (CDMA), cdmaOne, cdma2000, and Wideband CDMA.

Optical sensor 50 may be any optical sensor known in the art able to receive the information and data transmitted by optical transmitters 14. Optical sensor 50 generally converts optical information to an electric signal, and passes that converted signal to controller 40 for further processing. Optical sensor 50 may detect visible or non-visible light. In one embodiment, for example, optical sensor 50 comprises a Charge-Coupled Device (CCD) that converts data carried by visible light to electrical information usable by controller 40. In other embodiments, the optical sensor 50 comprises a receiver suitable to detect and convert data transmitted in the infrared portion of the spectrum by a Light Emitting Diode (LED).

Controller 40 receives the data from the optical sensor 50 and filters the data to produce selected content based on the user preferences in a selected user profile 42. In one embodiment, the data transmitted by the optical transmitters 14 comprises one or more alphanumeric codes or indicators that may or may not be followed by information. Different codes may be used to indicate different pieces of information, such as the type of business 12 that is transmitting the data, the name of the business, the contact information, and graphical indicia. Other codes may be used to indicate other information. Controller 40 may use these codes to determine the type of information being received and compare them with the codes stored in the user preference information. If the received codes are included in the selected user preference information, controller 40 may generate one or more control signals to output the content associated with the matching code to the display 22. The user may view all the received data, or only a selected subset of the received data based on the received codes.

As stated above, the selected content may be displayed to the user in a list format. However in one embodiment, the information is overlaid on an image. The wireless communication device 20 includes a camera 54 to capture an image of the geographic area 10 in which the optical transmitters 14 are located. Camera 54 may capture the image responsive to user commands, or automatically in response to detecting the presence of an optical transmitter 14. Controller 40 sends the image to the display 22 so that the user may see the captured image as a background on the display 22. Controller 36 may then generate control signals to “overlay” the selected content on the captured image to visually indicate the location(s) of the businesses 12 corresponding to the selected content.

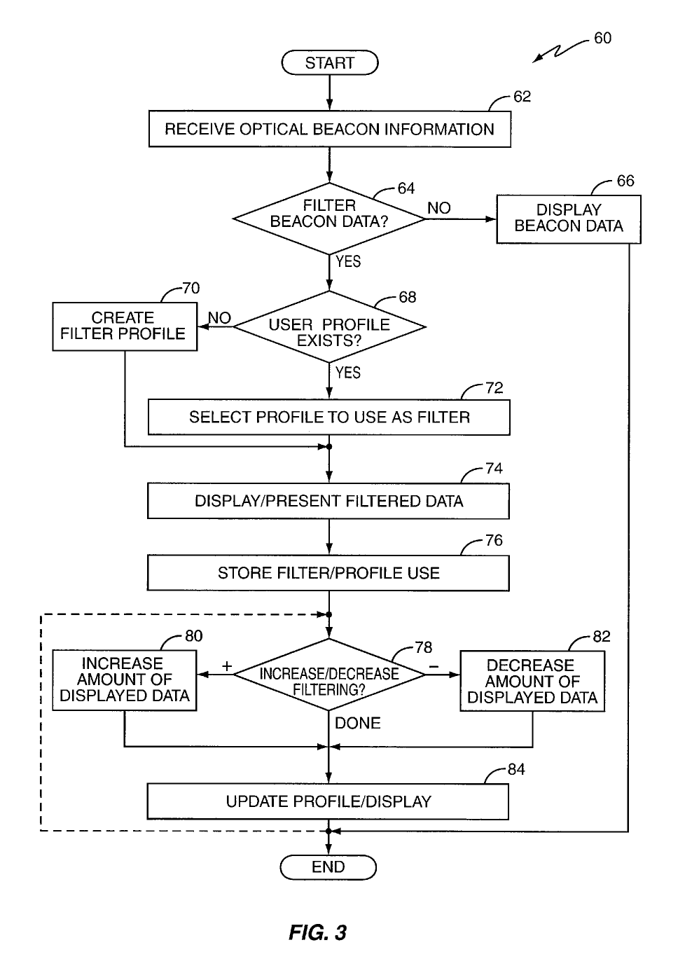

FIG. 3 is a flow diagram that illustrates a method 60 according to one embodiment of the present invention, and begins when the optical sensor 50 receives data emitted by one or more of the optical transmitters 14 (box 62). Upon receipt, controller 40 determines whether the user has enabled filtering (box 64). If not, controller 40 simply displays the received data (box 66).

If the user has enabled filtering, controller 40 determines whether one or more user profiles 42 exist in memory 38 (box 68). If not, controller 40 may create a user profile 42 to include default settings (box 70). The default settings may comprise information that cause only the names and/or icons of the businesses 12 to be displayed. Alternatively, the default settings may be based on historical data collected over time by controller 40 and stored in memory 38. Controller 40 could use this information to create a user profile. For example, controller 40 could store information reflecting the user's past history of viewing information relating to specific types of businesses. Likewise, the controller 40 could also store historical data that reflects the types of businesses and/or information that the user has typically excluded from viewing.

In another embodiment, the controller 40 may create a user profile 42 based on preference information provided by the user (box 70). For example, a user who wishes to know if there are any coffee shops in the area may use the interface 28 to manually input preference information relating to coffee shops. The information may include, but is not limited to, the name and/or type of a specific coffee shop, and the alphanumeric codes or indicators that correspond to this information. Alternatively, the user may navigate a menu system and select this preference information from a drop down list displayed on the display 22.

If one or more user profiles 42 do exist in memory 38, controller 40 may prompt the user to select a specific user profile 42 (box 72). As stated above, the user may employ the UI 28 to select a user profile 42. Controller 40 may then access the selected user profile 42, and use the preference information stored therein to filter the received data and display the selected content (box 74). Controller 40 may also update stored historical information based on the selected user profile 42 (box 76).

While the user views the selected content on display 22, the user may increase and decrease the amount and/or type of data that gets displayed (boxes 78, 80, 82). For example, a selected user profile 42 may select a text mode that displays only the names of businesses 12a-12d in a list format as shown in FIG. 1. If the user also desires to view the businesses' icons, the user can manipulate UI 28 to display graphical indicia along with the text. If the user desires less information, the user might manipulate the UI 28 to exclude the text from being displayed, and instead, view only the icons.

In another example, the user can switch between user profiles 42 to filter the received data for selected content. As an example, the user may categorize various preferences into a plurality of different user profiles 42. A first profile may indicate that controller 40 should only select and display content relating to restaurants, while a second user profile 42 indicates that controller 40 should only select and display content relating to sports-related businesses. Using the UI 28, the user may selectively switch between the first and second user profiles 42 to change the information on which controller 40 filters the received data. Thereafter, the user may manually manipulate UI 28 to increase and/or decrease the amount and/or type of selected content currently being displayed.

In another embodiment, a single user profile may include a plurality of different user preferences, each associated with a different set of preferences that controller 40 uses to filter the received data. The user may switch between the different sets of user preferences to change the filter using the UI 28.

As the user changes the user preferences to effect the selected content, controller 40 may refresh display 22 to output the new selected content. Additionally, controller 40 may update the appropriate user profile 42 to reflect the changes, as well as update any historical information stored in memory 38 (box 84).

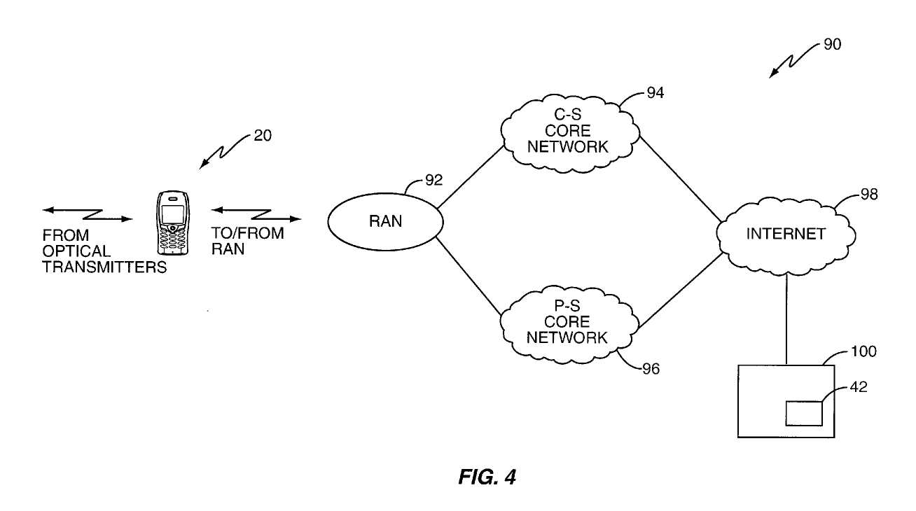

In the previous embodiments, the user profiles 42 that contain the user preference information are stored in memory 38 on the user's device 20. In alternate embodiments, however, the wireless communication device 20 may access and/or download the user profiles 42 from a server or other entity in a communication network. FIG. 4 illustrates one type of communication network 90 suitable for use in the present invention.

Network 90 comprises a Radio Access Network (RAN) that communicatively connects the wireless communication device 20 to the Internet 98 via a Circuit Switched Core Network (CSCN) 94 and/or a Packet Switched Core Network (PSCN) 96. Each of the RAN 92, the CSCN 94, the PSCN 96, and the Internet 98 are well-known in the art, and thus, not described in detail here. Upon receiving data from one or more of the optical transmitters 14, the wireless communication device 20 could initiate messaging using an appropriate protocol to download a selected user profile 42 from server 100. Once downloaded, controller 40 could filter the received data and display the selected content as previously described.

The previous embodiments specifically state several types of information that the controller 40 may display. However, those skilled in the art will readily appreciate that this information is illustrative only, and that the present invention is not limited to the type and/or amount of information that may included with or excluded from the selected content being displayed.

Additionally, the specification and figures embody the present invention in a cellular telephone; however, those skilled in the art will readily appreciate that this is for illustrative purposes only. The present invention may be embodied in any consumer electronics device including, but not limited to, Personal Digital Assistants (PDA), palm or laptop computers, satellite phones, and the like.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communication device comprising:
an optical sensor configured to receive data being transmitted by one or more optical transmitters;
a controller configured to filter the received data based on selected user preference information to produce selected content; and
a display to display the selected content.

2. The wireless communication device of claim 1 further comprising memory to store one or more user profiles, each user profile including one or more filters that specifies the user preference information.

3. The wireless communication device of claim 2 wherein the user preference information comprises one or more indicators that identify the selected content to be displayed.

4. The wireless communication device of claim 2 wherein the controller is configured to switch from a first filter to a second filter responsive to user input.

5. The wireless communication device of claim 2 wherein the controller is further configured to select a filter from the one or more user profiles responsive to user input.

6. The wireless communication device of claim 2 wherein the controller is configured to modify the user preference information included in the selected filter while the selected content is being displayed.

7. The wireless communication device of claim 6 wherein the controller is configured to increase or decrease the amount of selected content that is being displayed to the user responsive to user input.

8. The wireless communication device of claim 6 wherein the controller is configured to store the modified user preference information in memory.

9. The wireless communication device of claim 1 wherein the controller is configured to create a user profile based on the user preference information.

10. The wireless communication device of claim 9 wherein the controller is configured to create the user profile using information manually provided by the user.

11. The wireless communication device of claim 1 further comprising a transceiver configured to communicate signals with a wireless communication network.

12. The wireless communication device of claim 11 wherein the controller is configured to retrieve the user preference information from a server in the wireless communication network.

13. The wireless communication device of claim 1 wherein the controller is configured to execute a predetermined function based on the selected content responsive to user input.

14. The wireless communication device of claim 13 wherein the controller is configured to initiate a call to a telephone number included with the selected content.

15. The wireless communication device of claim 13 wherein the controller is configured to access a web server based on a Uniform Resource Locator (URL) included with the selected content.

16. A method of displaying information received from one or more optical transmitters, the method comprising:
receiving data transmitted by one or more optical transmitters at an optical sensor at a wireless communication device;
filtering the received data to produce selected content based on selected user preference information; and
displaying the selected content to the user.

17. The method of claim 16 wherein filtering the received data to produce the selected content comprises selecting a first filter from a plurality of filters responsive to user input, each filter including user preference information that indicates respective sets of selected content.

18. The method of claim 17 further comprising:
switching from the first filter to a second filter responsive to user input;
filtering the received data to produce new selected content specified by the user preference information in the second filter; and
displaying the new selected content specified by the second filter.

19. The method of claim 18 further comprising changing the selected content currently being displayed responsive to user input.

20. The method of claim 19 wherein changing the selected content currently being displayed comprises increasing or decreasing the amount of selected content that is being displayed responsive to user input.

21. The method of claim 16 further comprising creating a filter to include the user preference information.

22. The method of claim 16 further comprising executing a predetermined function based on information in the selected content responsive to user input.

23. The method of claim 22 wherein executing a predetermined function comprises initiating a call to a telephone number included with the selected content.

24. The method of claim 22 wherein executing a predetermined function comprises launching a browser application to access a web server based on a Uniform Resource Locator (URL) included with the selected content.
